(19) United States
(12) Patent Application Publication
(10) Pub. No.: US 2002/0046301 A1
(43) Pub. Date: Apr. 18, 2002

(54) System and method for integrating disparate networks for use in electronic communication and commerce

(75) Inventors: Mark Shannon, Rockville, MD (US); Alain Makris, Annapolis, MD (US); Kathy Maupin, Kensington, MD (US); George Fowler, Laurel, MD (US); Kate Senehi, Rockville, MD (US); Joel Lindsey, Kensington, MD (US); Jennifer Johannes, Germantown, MD (US); Phil Hand, New Market, MD (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc., Rockville, MD

(21) Appl. No.: 09/927,412

(22) Filed: Aug. 13, 2001

Related U.S. Application Data
(60) Provisional application No. 60/224,538, filed on Aug. 11, 2000.

(51) Int. Cl. G06F 9/46; G06F 9/00

(52) U.S. Cl. 709/328

(57) ABSTRACT

The present invention comprises a series of network connection elements including automatic plug-ins, configurable plug-ins and visual based system-built customized extensions. These elements are used according to embodiments of the present invention to serve as building blocks for connecting one or more disparate systems together. In some embodiments of the present invention, these building blocks can be arranged in a visual based environment to help facilitate integration of the systems in question. In a preferred implementation, an API server provides a four-pronged solution to provide integrated data access. The four components of this implementation are an Internal Integration Engine, ETL and B2B application adapters, an XML Gateway, and an application-specific High Performance Interface.

### RELATED APPLICATIONS

This application claims priority from U.S. Provisional Application Serial No. 60/224,538, filed Aug. 11, 2000, the disclosure of which is hereby incorporated by reference in its entirety.

### FIELD OF THE INVENTION

The present invention relates to a system and method for integrating disparate software and hardware systems to be used in electronic commerce and communication. In particular, the present invention pertains to a system and method for electronically connecting separate electronic systems in a modular and standardized manner so as to ease the management and optimization of electronic commerce and communication.

### BACKGROUND OF THE INVENTION

As businesses attempt to expand electronic commerce and communication abilities within their organization and across to business partners, they find themselves with limited and expensive options due to various technical problems. Common practice was for a business to write or purchase an application to carry out a business function according to a series of specifications and then to deploy that application via an internally engineered, and often proprietary, infrastructure consisting of servers, network security devices and network connectivity software. In essence, the technologies employed have been an extension of those used internally within the organizations. For many such businesses which have these proprietary systems, electronic commerce and communication with their business partners has entailed these organizations communicating via custom-built gateways to Legacy or near-Legacy systems. The resulting networks connecting the different businesses' internal systems often end up comprised by a series of frame-relay or leased line connections secured in many cases via commercially available electronic firewalls. Similarly, businesses often find themselves facing a similar scenario whereby difficulties are encountered integrating multiple internal systems. Regardless, integration between the two existing systems, whether it be internal or business to business, often occurs through a veritable patchwork of network address proxying and translation.

Communicating through such custom-built networks (such as wide area networks, local area networks, or intranets) causes a variety of problems. These complex systems require a great deal of resources to design, implement and maintain. Furthermore, whenever new application functionality is required, more resources must be expended to adapt any connections between the disparate systems.

New business applications need to meet broader industry specific needs such as integration-based Collaborative Planning, Forecasting, and Replenishment (CPFR) services by GlobalNetXchange of San Francisco, Calif., RosettaNet, Electronic Data Interchange (EDI), personal data assistant (PDA) support, integration-based business analysis and other extended solutions. Currently there are movements to integration applications. Many companies and analysts alike have recognized the sheer value of information that had been previously discarded or ignored as it passed through a businesses integration system. Recently companies have begun to use this information to make specific business decisions to ensure such things as on-time delivery and business partner performance. Because much of this type of information is commonly useful for a business's supply chain management (SCM), customer relations management (CRM), and business-to-business (B2B) performance, the integration of this information will further improve business optimization.

Overall, a desired business management application integration solution should preferably include six core strategic integration elements to deliver the most meaningful and valuable set of functionality required for users: (1) Enterprise Level Open Application Integration, (2) Open Standards Based Business-to-Business Integration, (3) Internal Application Process Invocation, (4) Business Partner, Process, Security and Workflow Management, (5) Enterprise Level Messaging Services, and (6) Integration based Business Analysis.

As such, a need exists for a more simple and efficient way to implement business-to-business electronic commerce and communication networks. Such a system or method should integrate various disparate networks within businesses and amongst business partners. The system and method of the present invention should further allow an integrated electronic network to be modularly connected such that compatibility is achieved across various disparate systems. Additionally, the system should allow network connections to be sufficiently flexible and customizable to easily support custom, in-house computer systems and other systems that are not operating on common standards.

### SUMMARY OF THE INVENTION

In response to these and other needs, the present invention comprises a series of network connection elements including automatic plug-ins, configurable plug-ins and visual based system-built customized extensions. These elements are used according to embodiments of the present invention to serve as building blocks for connecting one or more disparate systems together. In preferred embodiments of the present invention, these building blocks can be arranged in a visual based environment to help facilitate integration of the systems in question. In this way, knowledge of programming languages are not needed to integrate disparate networks.

Auto plug-ins according to the present invention provide pre-built integration flows that provide the transfer of data between systems as well as the transformation of the data into a desired or appropriate format. Additionally, the application programming interfaces (APIs) provide business process management to the integration flows which can be customized to a particular base system, platform, or application.

In embodiments of the present invention, the building blocks are used to interconnect a home system with an external application server. The APIs for the home system interface with a series of the building blocks described above while the external application server's APIs interface with a second set of building blocks. The result is that the two systems are fully integrated without the need for custom integration.

Other embodiments of the current invention can be used for self-contained integrations, distributed integrations, and extended integrations over, for example, the Internet. Furthermore, building blocks according to embodiments of the present invention additionally allow multi-platform integration.

Automatic plug-ins according to the present invention include building blocks to help integrate major industry leading applications and systems with other systems. These plug-ins are pre-configured and/or configurable so as to enable the integration to a base system (such as a particular application running on a given platform) with a minimum of input.

In providing an integration solution, the present invention employs an API server. The API server is a multi-platform data interchange and process management bus. In fact, the API server provides a single point of entry for ubiquitous data access to various business management applications via their specific native API interface. The API server then plays several roles within an integrated application framework. The API server serves as the primary conduit for a developer's internal application integration by providing object level data mapping services both in batch and on an event basis. The integration solutions formed using the API server facilitate the requirement to integrate each of its applications by building adapters to each one of its applications using a third-party Extract Transform and Load (ETL) tool. The ultimate goal of the API server is to improve a user's ability to integrate a developer's application as well as to simplify a user's ability to connect to external EAI and ETL products. The ability to connect all business applications together with little or no custom programming systematically reduces implementation time and cost and maximizes the benefits to a user from having integrated business applications.

The API server provides limited data transformation and aggregation capabilities to handle such data elements as user-defined columns and attributes. The API server also provides an interface to allow clients to do simple calculations to perform simple arithmetic like unit of measure conversions. Similarly, the API server provides a mechanism to launch and monitor both batch and event driven processes. Because the API server is the closest layer to a developer's applications, it will provide the entire internal workflow engine that will manage most internal business process automation tasks. All of these functions will be managed via a rules and mapping engine that will provide a mechanism for administrative users to program small modification to the existing business flows.

A second function of the API server will be to provide external access to application data and processes. The API server accomplishes this task in two different ways. The primary access method is via the use of adapters. One adapter will be used for EAI/ETL based applications, and the other adapter will be used to support B2B access. For those third party integration vendors that lack a true adapters connectivity to an application can be accomplished via generic access adapters such as flat file with XML support, generic RDBMS connectivity and message queues.

### SUMMARY OF THE DRAWINGS

These and other advantages of the present invention are described more fully in the following drawings and accompanying text in which like reference numbers represent corresponding parts throughout:

FIGS. 1 and 2 schematically illustrate the application integration system in accordance with an embodiment of the present invention;

FIG. 3 is a flow chart presenting the steps in a method for employing the system of FIGS. 1 and 2 in accordance with an embodiment of the present invention; and

FIG. 4 is a schematic illustration of an implementation of the integration method of FIG. 3 in accordance with an embodiment of the present invention.

### DETAILED DESCRIPTION OF PREFERRED EMBODIMENTS

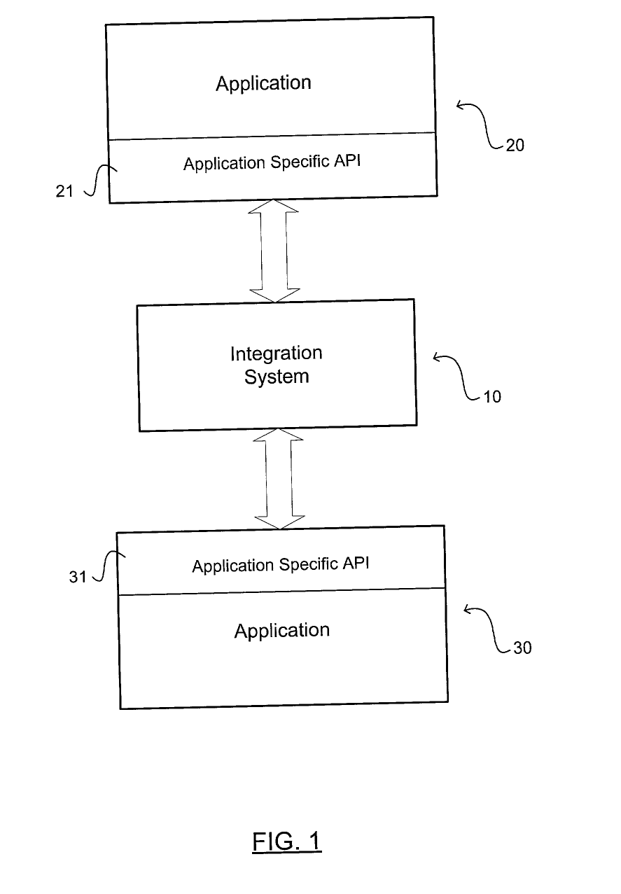

As generally illustrated in FIG. 1, the present invention provides an integration system 10. Specifically, the integration system 10 operates as an intermediary between two disparate business applications 20 and 30, to allow data exchange between to the two applications 20 and 30. Each of the applications 20 and 30 typically includes associated, application specific application programming interfaces (APIs) 21 and 31 that direct and format data to and from the applications 20 and 30. However, the data output from the first application 20 is may not be usable by the second application 30, and vice versa. For example, the data may not be the proper type, size or title, thereby complicating the use of one application's data in another application, even if the sharing of data would be highly advantageous. The integration system 10 addresses this problem by adapting the data from one application for use in a second application.

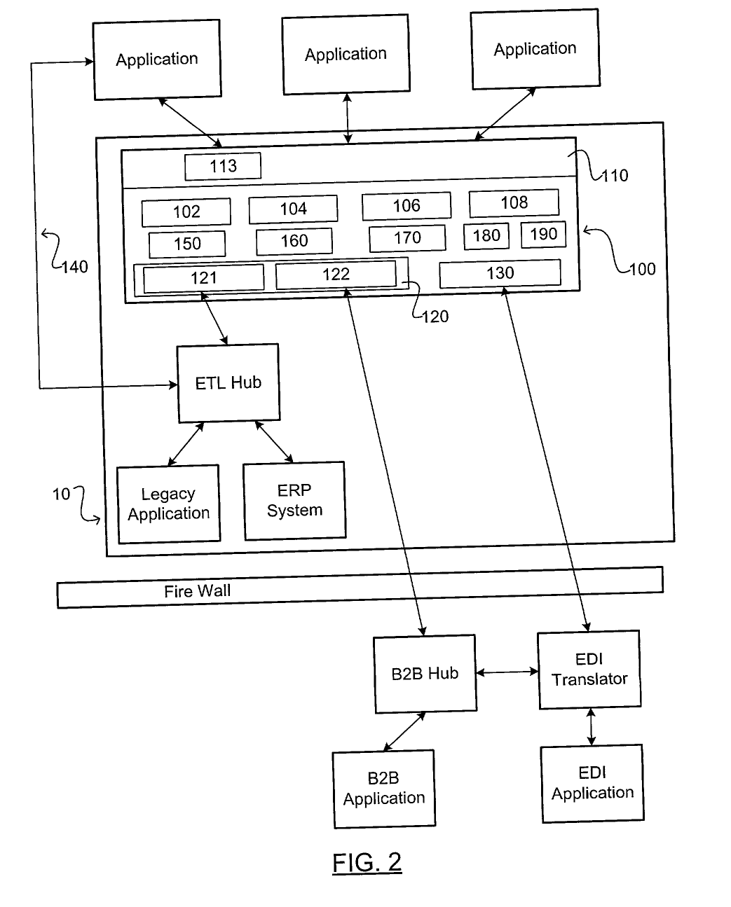

The integration system 10 is more fully illustrated in FIG. 2. and comprises an API server 100. The API server 100 provides developers with a single point of entry to enable all the required functionality to its users. Further, the API server 100 provides a mechanism that marshals data for both enterprise application integration (EAI) and B2B data transfer, process invocation, and security and internal workflow management. As the single, pass through data source the API server 100 also is a logical place to store and present useful business-related integration information for all various business management applications. These functions are all described in greater detail below.

In general, the API server 100 is a multi-platform data interchange and process management bus. The API server 100 provides a single point of entry for ubiquitous data access to various business management applications via their specific, native API interface (such as APIs 21 and 31 presented in FIG. 1). The API server 100 plays several roles within the integration system 10, such as serving as the primary conduit for a developer's application-to-application integration by providing object level data mapping services both in batch and on an event basis. Additionally, the API server 100 provides limited data transformation and aggregation capabilities to handle data elements such as user-defined attributes. Similarly, the API server 100 provides a mechanism to launch and monitor both batch and event driven processes. Because the API server 100 is the closest layer to the developer's applications, the API server 100 can provide an internal workflow engine that will manage most internal business process automation tasks. All of these functions will be managed via a rules and mapping engine 106 in the API server 100 that provides a mechanism for administrative users to program small modification to the existing business data flows.

The second function of the API server 100 is to provide external access to an application's data and processes. The API server 100 accomplishes this task in two different ways. The primary access is through the use of building blocks. For instance, one building block may be used for EAI or extract, transform and load (ETL) based applications and the another building block may be used to support B2B access. Data transfer between disparate applications may also be accomplished via an XML gateway 130.

The API server 100 may includes six layers, including an application connectivity layer 102, a data normalization layer 104, a rules and mapping engine 106, a messaging agent 108, an XML gateway 130, and the external adapters 120. The API server 100 may be deployed as one application unit. The API server 100, however, preferably has the ability to allow users to upgrade the logic that exists within each one these six areas as new releases are created and functionality is enhanced, repaired or changed. In this way, the API server 100 may be adapted to new applications and/or the needs of different users.

The application connectivity layer 102 provides the transport mechanism for data to move from remote application instances to the API server 100. This layer's ultimate responsibility is to mask the complexity that is required to expose the data and process objects associated with different business management applications. Over the long-term, the connectivity layer 102 is comprised of numerous product APIs that are designed to access all the data objects and processes available within the target applications. These APIs will contain both the data transport capabilities and business logic to handle any data object from prespecified application, regardless of whether the transport requirements are batch or transaction based. As data objects are retrieved in their native format the data objects may be mapped to another related application or will be passed to the data normalization layer 104. The application connectivity layer may use whatever technology is necessary to ensure the fastest available interface to the API server 100. This functionality improves the value of the API server 100 to the end-user as the end user does not need to secure the tools otherwise required to integrate several disparate applications.

The application layer 102 may also serve as the primary reporting layer for all transactions both in and out of business management applications. These layers will initially be output to files, however subsequent releases will include the ability to make logging updates to a relational database and to signaling network management protocol (SNMP) traps.

In contrast, the data normalization layer 104 is the layer where data that is retrieved from an application is normalized for use by other applications. Where appropriate to improve performance, similar data elements that exist within several applications may be normalized and take on a more general definition. For instance, data can be translated into a generic representation of the data object when data is retrieved from a source application. Similarly, data may be converted to a product specific version of that object when the data is being sent to a target application. The data normalization layer 104 may also operate to pass through data elements that appear in only one application or are used differently for application to application.

Rules and Mapping Engine

The API server 100 may further include the rules and mapping engine 106. The rules and mapping engine 106 is the layer where data contained in one business object for one application is mapped to the data contained in another application. This layer will be used exclusively for internal integration so that most business flows can be hard coded by developers to ensure optimal performance. As new integrations are released, new additional mappings are added to the rules and mapping engine 106.

The API server 100 may alternatively have a programming environment that allows trained implementers to modify current functionality, manage user defined attributes, or perform various data transformation activities. The programming environment that the technical staff will use to modify the rules that exist within the rules and mapping engine 106 typically features a high level text based programming interface that will do very rudimentary validation for programming syntax violations.

Generally, a distributed programming language, such as Java, is used within the API server 100 to allow data to be mapped from one application to the next. This language exposes the classes and methods associated each adapter to enable a user to manipulate the data with the use of with a set of data transformation functions that can be used to perform various data mapping and transformation activities on related data objects. In an alternative embodiment, a Java-like pseudo language may be used to achieve a greater ease of integration.

To allow the greatest flexibility to its users, the API server 100 may provide the ability to develop hard coded mappings and design time that can be changed at runtime where conditional logic warrants are often used to facilitate integrations in an auto-plug in where a default constant may be added when a null value is received from an external source.

The API server 100 may include preprogrammed mappings between each business management application according to required business solution functionality. This integration provides customers with an out-of-the-box, end-to-end solution that transfers between related applications. Data can be routed either point-to-point or using message queues to transport data between applications.

Users of packaged integrated business management applications may find that the majority of their business mapping requirements will already exist within the pre-configured integrations. However, wherever functionality is lacking, the client have the ability to modify on site using the rules and mapping engine 106. Some of the reasons a user's clients may require the modification of these data mappings include the use of suffix codes and other string manipulation needs, as well as, unit of measure conversions between systems and use of user-defined attributes on the data. A list of possible operations for the Rules and Mapping Engine 106 is attached as Table A.

In a preferred embodiment, the API server 100 further includes a messaging agent 108, where the messaging agent works together with the above-listed components to gather and employ data between one or more applications. The messaging agent 108 utilizes a publish-and-subscribe posting mechanism to move the data through the data normalization layer 104 and to the appropriate API in the application connectivity layer. The messaging agent 108 will primarily be used to post external data from external sources to the appropriate queue for the target application. The messaging agent 108 may have additional internal mapping requirements for this functionality as well.

The XML Gateway 130 is the component of the API server 100 that exposes the data externally either within a self-documented flat file or through a real-time XML connection portal. The data that is exposed via XML 130 is the high-level business representation of the underlying application. Several data type definitions may allow the user to retrieve the appropriate definition type for that object's intended use. The XML gateway 130 is described below in greater detail.

The adapters 120 allow the integration system 10 to move data in and out of the API server 100 via technology provided by a select group of integration vendors. The adapters 120 provide a common access point that will allow developers to continue development of pre-canned sub-integrations and auto plug-ins.

The API server 100 generally uses several programming tools commonly used throughout various business management applications. Because the API server 100 generally provides ubiquitous access to all applications, the API server 100 may include all of the technologies currently in use today. These tools include Enterprise Java Beans, pure JAVA, C++, Corba, JMS, JDBC and other similar technologies.

The API server 100 preferably supports several different operating platforms. For instance, the API server 100 may operate using Windows NT 4.0 SP6 and Windows 2000 SP1, HP-UX 11 and 11i, SUN Solaris 2.7 and 2.8, or AIX 4.3.3 and 4.3.4. The API server 100 is also preferably compatible with environments that utilize clustering as a means to scale applications. Specifically, Legato and Veritas compatibility are desirable.

The API server 100 is generally deployed and installed on the same server as the business management application exists, where the application permits. The API server 100 must have the capability to connect to applications that exist on the same server. This feature gives the API server 100 the ability to be deployed on a stand-alone server for those cases where performance and scalability is an issue.

The API server 100 also generally includes some type of error handling. Error handling, i.e. storage and analysis of errors, may be provided through: (1.) a standard output; (2.) a flat file with transactional and job summary level output; (3.) a relational database; (4) a Java ® Message Service (JMS) Message Output; or (5) a signaling network management protocol (SNMP) Trap.

In general operation, the API server 100 is a relatively fast computer to meet the needs of customers. Currently record volume requirements put most client data volume requirements between 100 thousand and 60 million rows. Given an average batch window of one hour, the API server 100 should accommodate those clients that have as many as 10 million entries within a normal batch cycle. Thus, the average transaction volume is in the range of 150 to 200 thousand transactions per minute.

Returning to FIG. 2, a preferred implementation of the API server 100 employs a four-pronged solution to provide integrated data access. The four components of this implementation are (1) an Internal Integration Engine 110, (2) ETL and B2B adapters 120, (3) an XML Gateway 130, and (4) an application-specific High Performance Interface 140. Each component is specifically designed to provide business management products with the most robust integration footprint available.

Internal Integration Engine

The API server 100 provides a common integration platform for internal integration to pre-specified, related business management products. Typically, these applications are developed by a single developer or a team of related developers. Specifically, the API server 100 will connect to various business operation applications via those applications' native APIs. Once data is retrieved by the API server 100, the data may either be mapped directly to the data object of another application or exposed to the common data normalization layer 108 that subsequently maps the data to an external Adapter or XML-based data transport mechanism. Because the data exists as an object within the common data normalization layer, mapping objects from one application to the next can be done fairly rapidly. Information that is passed internally will then be forwarded to the target application via an application's native API. The architecture may either use either message queues or direct point to point access to provide direct application updates. This function allows data to be easily transferred in either a batch or event based fashion. Similarly, both batch and event based repair algorithms can be executed as arguments that are passed to the target application using the same transport mechanism. The advantage of this methodology is that it is inherently scalable because data transfers and process invocations can be run within a multi-threaded and parallelizable run-time environment. Additionally, each thread can be assigned the task of imposing the specific business logic that is required for integration to the target application in either a stateful synchronous or stateless asynchronous fashion to further streamline the data input process.

One implementation of the API server 100 includes Universal Data Model (UDM) building blocks to integrate related applications. The UDM building blocks are generally used to build layers of integration solutions on top of applications. The UDM building blocks operate at the expense of increasing the number of connection for a direct integrator. Simultaneously, utility building blocks may be also be employed in API server 100 for sorting and extracting data between related business applications. The internal integration engine 110 may be custom developed as needed by a developer, or commercially available integration applications are available. For instance, Business Integration Studio, produced by Vignette Corp. of Waltham, Mass. is an integration program that may be used to share data between two different applications.

In a preferred implementation, the internal integration engine 110 further includes business logic 113. The business logic 113 is added on top of the building blocks to as desired features, such as error checking, logging and tracing, as well add improved data, user-friendly presentation of the data. The business logic 113 may be adjusted to allow the internal integration engine 110 to adapt to new applications.

Adapters

The API server 100 may be further functioned to integrate dissimilar, locally operated business management applications through the adapters 120. Specifically, where data exposed to the normalization layer 108 in the API server 100 is present in one business management application and is already normalized, only one building block or adapter is typically required to access this data. Adapters 120 may be used to provide connectivity to a applications that require no extra relational integrity or business functionality. The adapters 120 may generally provide greater scalability and deployment flexibility by relying on the underlying threaded access of the API server 100. For instance, data formats and overall process objectives generally differ between business management applications that focus on supply chain management optimization applications and applications that focus on B2B e-commerce. Nevertheless, two corresponding data blocks may be constructed to meet both these types of business management applications.

The adapters 120 can be leveraged to provide advanced mapping, data transformation and aggregation functionality. For instance, the adapters 120 may transfer the data from an application to ETL and B2B systems that are better equipped to handle these functions. Because many of the operations performed in ETL versus B2B integrations may differ drastically at times, the API server 100 preferably includes two adapters to suit these two distinct purposes.

Similar to the above-described UDM building block, an ETL Adapter 121 (also called an EAI adapter) can provide a proprietary graphical interface to the API server 100. The ETL adapter 121 exposes both data objects and processes for batch based applications. The ETL adapter 121 further enables both event and batch based create, read, update and delete (CRUD) operations as the ETL adapter 121 externally exposes the data to application specific subintegrations.

The ETL adapter 121 allows a user to choose the high-level data object with which the user plans to work. This data may include an item identifier, such as a SKU, along with subcomponents of the object. The user may 1) choose the installed applications to update and 2) decide what operations to perform on that data object. The operations typically include insert, update, insert, delete, cascading delete, and view. Other operations may include batch and event-based versions of the previously listed operations. Operations that are available to an installed applications may be visually displayed to users.

Referring again to FIG. 2, the API server 100 may further include a B2B adapter 122. Much like the ETL adapter 121, the B2B adapter 122 provides external integration capabilities to participating application developers, such as the top tier vendors described below. The B2B adapter 122 differs from the ETL adapter 121 in that the B2B adapter 122 provides more event-based functionality. This is needed because many EAI vendors operate on either a commercial or proprietary messaging bus. The B2B adapter 122 works with an underlying message bus for to provide effective data marshaling capabilities between the external B2B systems and the API server 100. The B2B adapter 122 can also be deployed as a component of a private process for EAI tools that provide workflow and business process management capabilities. As with the ETL adapter 121, the B2B Adapter 122 provides an element upon which more complex solutions can be based.

As described above, various business logic 113, such as error detection and reporting, may be added to the adapters 120 as needed to satisfy the needs of users. Adapters 120 may also serve as the foundation for the development of new business management applications and integration based business solutions.

When forming adapters, an encryption algorithm is required for the Relational Database, Flat File, LDAP, and Environment Management adapters. This algorithm will allow these adapters to be deployed in highly secured environments where there are standards that prohibit the use of clear text configuration information in initialization files, databases, and within the system environment. The encryption mechanism should include two algorithms that can be encrypted or decrypted by only the specific adapter that is used in the integration flow. This feature enables users to encrypt or decrypt a stream of data to and from a file or database. This feature further allows users to store passwords and login ids in a format other than clear text.

Performance concerns should also be considered when forming adapters. While performance is not the ultimate goal of the API server, acceptable performance can be achieved a number of different technologies and methods will be employed to ensure the ultimate scalability for this product. These methods will differ from adapter to adapter due to the underlying technology that is in use. However, in general, data caching to databases and files, along with cursoring, parallelism, multi-threading, and pipelining may be employed to ensure overall speed and performance where the API technology will allow. Other options include developing specific algorithms to automatically divide data within the API server, so that it is passed more efficiently from system to system. These algorithms will include dividing data into logical chunks based upon cardinality or a simply as alphabetical order.

XML Gateway

The API server 100 may also have the extensible markup language (XML) interface 130 that can be used to expose generically tagged hierarchical data to any external applications and integration systems. Like hypertext markup language (HTML), XML is a programming language that defines distributed applications for use over a distributed network, such as the Internet. Whereas HTML applications are generally used for multimedia presentations, XML applications generally function to acquire and transfer data. The XML interface 130 provides generic access to application data. The XML interface 130 also a user or application to send XML encoded arguments to specific applications to launch secondary processes. Because XML is self documenting, both user and developers customers may leverage the XML interface 130 to provide both integration and extended business functionality.

The XML gateway 130 provides a file-based access method so that information can be easily read from an XML based flat file that is stored on the API server 100. Additionally, the XML gateway 130 provides an asynchronous XML messaging portal that allows data from an application to be posted via a live real-time connection.

While slower in performance of applications than the internal integration engine 110 or the API server 100 Adapters 120, the XML gateway 130 allows users to get data in and out of disparate business management applications, where the applications are not adapted to share data. In a preferred embodiment, the XML gateway 130 is adapted to comply with current industry leading XML-related standards, such as extensible stylesheet language (XSL), Simple Object Access Protocol (SOAP), and Lightweight Directory Access Protocol (LDAP). SOAP is an XML-based format for specifying method invocations between computer systems. SOAP is completely independent of any platform, operating system or programming language and can easily be used over the Internet with the ubiquitous HTTP and SMTP protocols. Specifically, the XML interface 140 may pass XML arguments back to the specific application to invoke required processes. It should be appreciated that the XML gateway may be likewise adapted to use emerging and future developed technologies as required for the transfer of data.

Business Operation Application High Performance Interface

Interrelated applications may have a low-level, JAVA database connectivity (JDBC) based application interface. While this interface does not provide the ease of implementation that the three above described interfaces, the JDBC interface provided the fastest means to access data across many related business applications. This implementation is similar to various, well-know enterprise resource planning systems, in which data volume and integration performance requirements have been relatively large. Specifically, the applications may bypass any integration and merely access data stored in an information storage device, such as a database. The data has been previously deposited by another application in a usable format.

For applications in which the logic to import the data is complex and time sensitive, staging tables are used in the import of the data. Database storage procedures, such as those implemented by Oracle®, are then used to process and aggregate the data before the data is reaches a final repository. This configuration puts the most complex processing logic at the database level where it can be performed most efficiently. For other types of business applications, product specific JDBC drivers may be written to connect the applications directly to various databases.

Returning to FIG. 2, the API server 100 may further include an execution manager 150, a security interface 160, a reporter 170, an analyzer 180, and scheduler 190.

To fulfill the process invocation requirement of an integrated business application framework, the API server 100 may further posses the ability to both start and monitor various business application processes. The process execution manager (PEM) 150 is generally built on the same technology as the rest of the API server 100, but serves the distinct purpose of remotely starting both batch and event based processes within each applicable business application. The PEM 150 then monitors the progress and completion status of the initiated applications. Moreover, the PEM 150 manages specific dependencies that must be met before any task or application is invoked. For example, the PEM 150 may sequence and multistream jobs. The PEM 150 may also interact with the external system environment to complete such tasks as executing external programs via a shell or remote shell based routine and retrieving external environment values from the system environment, configuration file or the Windows® registry.

End-to-end integrations and business-workflow operations will be constructed by creating deployment targets with the above-described rules and mapping engine 106. The rules and mapping engine 106 allows the user to compile the preprogrammed and custom data integrations and to deploy them as executables. By developing smaller integrations that execute a small set of functionality the user can develop integrations that are modular and reusable. This will also eliminate the need to recreate entire end to end integrations when more that one application is used. The PEM 150 manages the execution of jobs that are registered in its database. The PEM 150 controls when and how mappings are executed to provide application updates. This feature enables a developer to program fairly complex workflow oriented processes between one or more applications. This workflow component is intended to provide developers with a level of abstraction from the actual programming language to allow developers to reuse previous mapping to create more complex end to business solution processes. The PEM 150 manages processes that are deployed across servers clustered scalability purposes.

The PEM 150 maintains a relational database that will serve as a repository for all runtime integration configuration information. Moreover, the PEM 150 has the ability to invoke subintegrations based upon input from several external events. The PEM 150 may have a graphic user interface (GUI), typically with columns defining job name, triggering event and time, and job dependency, where the dependency column allows a user to provide conditional logic for job execution. The PEM 150 also generally has the capacity to write logs to standard output, log files and SNMP traps.

The PEM 150 may also include, but not be limited to, command line arguments, scheduled jobs, events posted to a queue, file modification, and database triggers. The fact that the PEM 150 can be launched from command line arguments allows a user who prefers other scheduling tools such as AT, CRON, CA Unicenter, or Maestro to write simple scripts that are launched from those products and call the PEM 150 to run application integrations. Similarly, the PEM 150 contains a scheduling tool to allow users that do have these products to have a mechanism to launch subintegrations from the PEM 150 without requiring external scheduling tools. The PEM 150 handles job execution in batch, transactional or daemon modes. Therefore jobs can be launched just as easily from database triggers and events to a message queue as with a timed batch update.

Because the PEM 150 allows events within one job to systematically trigger the events within another, the PEM 150 has the inherent ability to do job and workflow management. The PEM 150 generally has the ability to move the data from one adapter and move it into one or more adapters based upon specific execution criteria. Again, using the same event-based triggering methods, the PEM 150 may be able to manage data flows in and out of several different systems simultaneously. This functionality also improves scalability by allowing several integrations to be set up in parallel to access the same target. By setting up integrations that pass data to several parallel paths, scalability can be achieved in manner that is similar to the way that stateless Enterprise JavaBeans (EJBs) work within an application server. The PEM 150 has its own configuration data repository to store the information about each job that is to be run.

The PEM 150 should generally be available 24 hours a day to manage jobs that run throughout the day. Additionally, the PEM 150 usually recognizes when a second instance is available to provide fail-over when one the primary instance is down. In this way, the sending of a call from secondary system to the primary system on a regular interval ensures that the system is still operational. If the primary system is down the secondary system will take over.

As suggested above, the process execution manager 150 may also be used as an internal workflow-monitoring tool. In this way, the process execution manager 150 provides users with the ability to model complex business integration processes, based upon specific process staging criteria. The user may use the internal programming interface to design end to end processes using a set of predefined status checkpoints. The user may then model many processes or varying levels of complexity.

The process execution manager 150 may be used by either command line arguments sent through the XML interface, behavioral inputs sent through the adapters 120 or a graphical interface (not illustrated) that is created on top of the API server 100.

Returning to FIG. 2, the API server 100 may further include the security interface 160. Web implementation of a suite of products provides developers with a new a complex set of security concerns. Integration via the API server 100 also raises security issues. Therefore, the API server 100 preferably has the ability to pass security-related information from outside of the system 10 to any applicable application. Similarly, the API server 100 may have security specific APIs to synchronize information between application. To this end, the API server 100 may support commercial security protocols, such as lightweight directory access protocol (LDAP) and Java Naming and Directory Interface (JNDI). Similarly, the security functionality may be extended to take advantage of the strength of other third party products, such as security applications built by Verisign® and Entrust®.

The logging and reporting of process status and failures are desirable functions of a successful integration system. In another embodiment, the API server 100 may therefore have a logger 170 to provide multi-tiered logging capabilities such as logging at the transaction level, the process summary level, and at the operating system level with return codes. A record of those logging on to the API server 100 may initially be a flat file with the exception of the operating system response that will go to standard output where it can be redirected into a log file. The API server 100 may alternatively log these messages into a database and provide an interface for transactional non-reputation and document archival. However, the API server 100 may include integration with SNMP compatible system management tools.

Referring again to FIG. 2, another implementation of the API server 100 includes the analyzer 180. Integration may be driven by the desire to leverage the recent, vital business information from the data that passes through an integration system 10. This need is especially prevalent in the B2B sector in which measurements of minute integration details, such as information response times, can be used to drive decisions surrounding profit and loss. Moreover, many application developers are trying to expand their capabilities in these areas to augment value gained by implementing back office automation systems. A developer may similarly leverage this type of integration based information to extend the value proposition of its other optimization engines. Within the integration system 10, the data that is used to drive the business applications pass through the API server 100 at some point in time. Because of this information, there is a wealth of information about each integration transaction that can be leveraged to drive profitability. When used in environments such as B2B exchanges the information can be sold to trading partners to provide additional value and drive specific business choices. This type of information is very similar to the performance metrics gathered by typical CRM systems. Further, specific key process indicators can be created to address the effectiveness of a specific integration solution.

Referring back to FIG. 2, another implementation of the API server 100 may also include an integration management services scheduler 190. The scheduler 190 is generally a component of the IS 300 whose primary function is to maintain documented code control for integrations that are created and modified at the field level. The scheduler 190 provides check-in and checkout services for integrated applications written using the API server 100. This will allow clients to determine what version of code to matriculate into production. The service will include code archival, date and author logging services.

The scheduler 190 may also have a text-based CRON or AT style scheduler with which users define either timed or triggered events that start integrations. The scheduler will also have the capacity to trigger and monitor events run serially and in parallel and appropriately pass return codes to external targets like SNMP or to as parameters to other integrations.

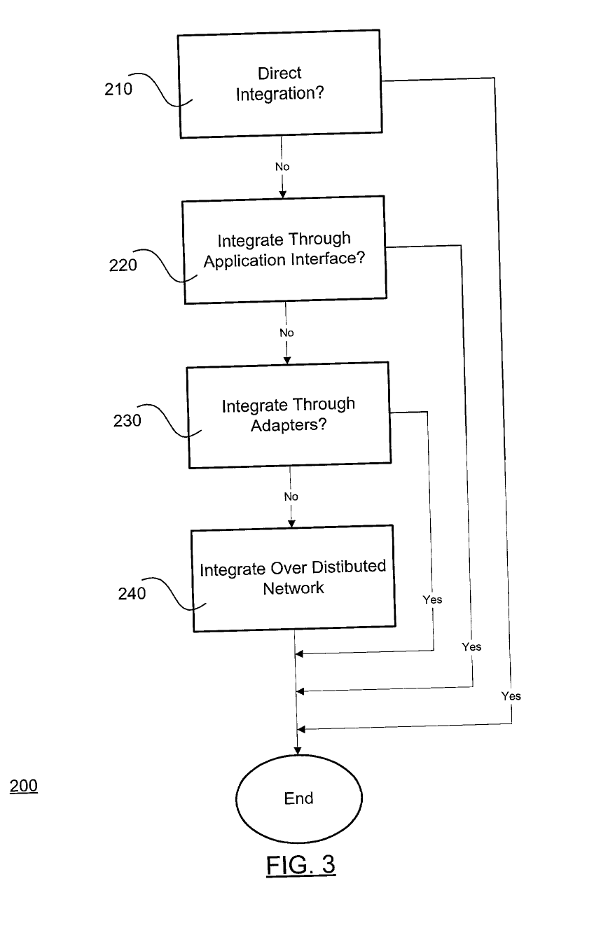

FIG. 3 illustrates a method 200 for integrating disparate applications using the integration system 10. Specifically, the method operates according to the relationships between the disparate applications. Where applications are co-developed, either through a single developer or coordinating developers, the applications may be directly integrated, step 210. Generally, these applications are designed to co-exists, or through their related development can inherently coexist. The direct integration step 210 may be implemented through a device such as the above-described internal integration engine single 110. Alternatively, the related applications may connect to exchange information through an application interface, step 220. I this way, the related applications may interact without an integrating server or other type of intermediate API.

Returning to FIG. 3, applications may alternatively be integrated though the use of adapters, step 230. For instance, the above-described ETL adapters 121 allows data exchange between disparate applications running within a firewall. Typically, the ETL adapters 121 connect applications running within a single system or network. Conversely, the B2B adapters 122 allow data exchange between disparate applications separated by a firewall. In this way, users may cooperate to share data between unrelated applications. However, an adapter must be specifically created to server as an intermediary between two distinct applications. Likewise, the adapters generally need to be updated for new versions of the applications.

Users may alternatively transfer data between dissimilar applications through over a distributed network, step 240. For instance, the XML gateway 140 may connect applications across a firewall, even if an adapter between the applications has not been created.

It should be appreciated that data may be exchanged between applications using a combination of the steps 210-240. For instance, applications may directly integrate to exchange certain data while exchanging other data over a distributed network.

A developer may use the integration method 200 to form business partnerships with other application developers. The developer may deliver integrated applications using the technology product offerings from several different application developers. Developers may provide applications that have varying degrees of cohesion within the above-described integration infrastructure. The different levels of cohesion are based upon developers specific levels within a partnership program. The integrated business applications may range from originally developed products at the highest tiers to simple reseller or integration certification agreements at the lowest tier.

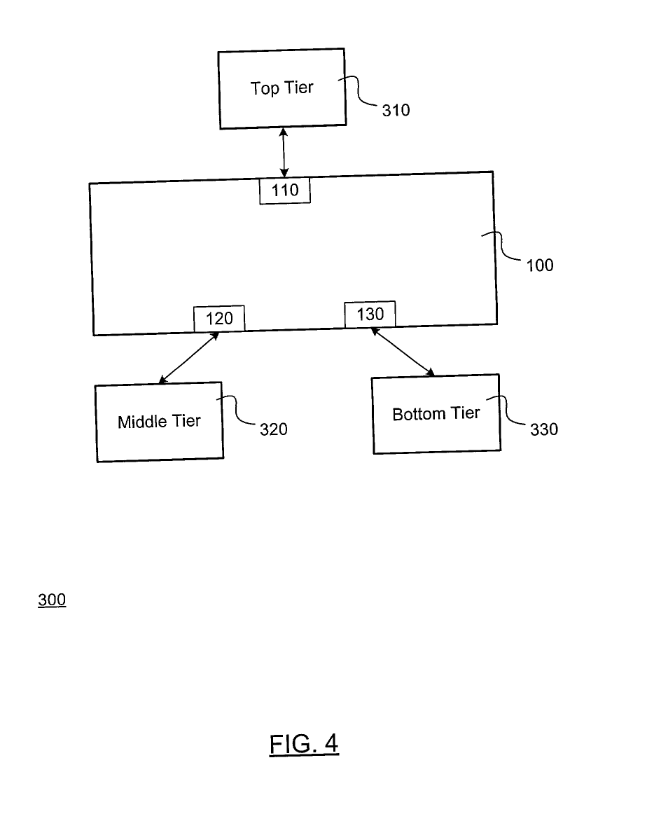

In one implementation illustrated in FIG. 4, this integrated multi-vendor strategy is a three-tiered partner hierarchy. Top tier vendors, the highest level vendors, may be determined both by their breadth of functionality and performance that they add to the business management integration solution, as well as their potential market impact. High tier partners may directly integrate with a developer's applications, as described above in steps 210 and 220. For full integration, the developer shares much information on its applications with a partner. While, most internal integrations are done via the API server 100, top-tier vendors applications may provide advanced data transformation and aggregation services that are not readily available within the API server 100. The top-tier partners may also provide high performance relational database management systems (RDBMS) adapters 120 having a mechanism to circumvent the API server 100 and to access the other applications' data at the database level. This function allows a developer to provide easy to use preconfigured subintegrations and plug-ins, as well as a fast performing integration solution.

Middle tier partners may integrate with a developer's applications through adapters as described above in step 230. For the level of integration, the developer shares some information on its applications with a partner, but much less than required for full integration. Lower tier partners may integrate with a developer's applications through a distributed network, as described above in step 240. This relationship allows the developer to reveal only a limited amount information to the partner by using the XML interface 130 of the API server 100 to meet generic client integration requirements. Advanced integration requirements may be customized according to the technical and application needs of users.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

| Method Name | Description |
|---|---|
| Variables Method | |
| Create Variable | Create Object variable of any data type |
| Delete Variable | Delete existing object variable |
| Assign Value | Assign the value that exists within one object to another |
| Constant | Maintain a global value variable |
| Read Value | Read a value from a pointer or node |
| Write Value | Write the value that exists with a pointer or a node |
| Delete Object | Delete Object Variable to clean up memory space |
| Create List | Create a list structure including a tree |
| Create Array | Create an array structure for complex lists |
| Get Parent | Get parent list or tree node |
| Get Child | Get child list or tree node |
| Find Node | Do a search to find a node given a specific value |
| SORT LIST | Sort list in ascending or descending order by criteria |
| IF_EXISTS | Return a Boolean |
| Is_Unique | Return if the value is a unique value in a list or tree |
| Filter | Retrieve specific information in list based upon criteria |
| Database Access | |
| <adapter dependent> | |
| Select | Read Value from a database |
| Insert | Add Value to a database |
| Update | Modify a specific record value in a database based upon criteria |
| Delete | Remote Value from a database |
| Insert and Update | Modify a specific record value in a database based |
| | upon criteria, if it DNE add it. |
| Replace | Replace the entire record in a database |
| Send Database trigger | Send command to database to execute a trigger or |
| | stored procedure |
| Sqlexec | Execute user-defined SQL |
| Table_Lookup | Quick lookup for information in a RDBMS table |
| Value_Lookup | Quick lookup for information in a RDBMS value |
| Truncate | Delete contents of an entire table |
| Commit Quantum | Commit after N records are passed |
| String Methods | |
| Left Trim | Trim N chars from the left of a string |
| Right Trim | Trim N chars from the right of a string |
| Trim Both | Trim N chars from both ends of a string |
| Substring | Remove character from the Nth position of a string |
| Merge/Concatenate | Merge two strings together |
| Get Standard Input | Retrieve information from the UI |
| Put Standard Output | Pass information to the UI |
| Summary | Pass summary to the UI |
| Assert_maxlength | Prevent string from exceeding N chars |
| Convert_to_date | Convert Number or string to date |
| Find_token | Parse string and find a value return position |
| StringBoolMap | Map string to Boolean value A = True/1 |
| Encode | Encrypt String via encryption algorithm |
| Decode | Decrypt String via encryption algorithm |
| Pad_leading_chars | Pad the beginning of a string with a specified |
| | number of a single character or one instance of a |
| | string |
| Pad_trailing_chars | Pad the end of a string with a specified number of |
| | a single character or one instance of a string |
| ParseString | Parse a string |
| Time Calculations | |
| Current_time | Get current time from the system |
| Getdate | Get current date from the system |
| Workdayscalendar | Get calendar that corresponds to the specific work |
| | week (n − 48) |
| Incrementdate | Increment date by N days |
| Decrementadate | Decrement date by n days |
| Calculations | |
| Add | Simple arithmetic (addition) |
| Subtract | Simple arithmetic (subtraction) |
| Multiply | Simple arithmetic (multiplication) |
| Divide | Simple arithmetic (division) |
| Mod | Simple arithmetic (division return integer) |
| Increment | Add 1 to ++ |
| Decrement | Subtract 1 from − − |
| Average | Compute Average value |
| Count | Count number of objects |
| SetConversionfactor | Set factor to multipiy by |
| Mapping Related | |
| Operands | |
| If | Conditional Operand |
| Case | Condition Operand |
| Loop | Loop through a step until a certain condition is |
| | met |
| While | While a condition is true loop |
| GetLDAPVal | Get and LDAP value for use security information |
| | passing |
| SetLDAPVal | Set and LDAP value for use security information |
| | passing |
| GetBooleanval | Get the Boolean value for this object. Derived |
| | class of Boolval above. |

What is claimed:

1. A system for integrating disparate applications, said system comprising an API server having an internal integrator, an ETL adapter, and a B2B adapter.

2. The system of claim 1, wherein said ETL adapter integrates applications within a firewall and said B2B adapter integrates applications separated by the firewall.

3. The system of claim 1, wherein said ETL adapter and said B2B adapter include business logic.

4. The system of claim 1 further comprising an application interface.

5. The system of claim 4, wherein said application interface is JAVA-based.

6. The system of claim 1, wherein said API server further includes an XML gateway.

7. The system of claim 6 further comprising an application interface.

8. The system of claim 1, wherein said API server further includes an application connectivity layer.

9. The system of claim 1, wherein said API server further includes a data normalizer.

10. The system of claim 1, wherein said API server further includes a rules and mapping agent.

11. The system of claim 10, wherein said rules and mapping agent is a JAVA application.

12. The system of claim 1, wherein said API server further includes a messaging agent.

13. The system of claim 1, wherein said API server further includes a process execution manager.

14. The system of claim 1, wherein said API server further includes a security interface.

15. The system of claim 1, wherein said API server further includes a log reporter.

16. The system of claim 1, wherein said API server further includes a data analyzer.

17. The system of claim 1, wherein said API server further includes a services scheduler.

18. The system of claim 1, wherein said applications are business management applications.

19. A method for integrating disparate applications, the method comprising the steps of:
directly integrating the applications through an API; and
integrating the applications through a data adapter, said data adapter being an ETL adapter or a B2B adapter.

20. The method of claim 19, wherein said ETL adapter integrates applications within a firewall and said B2B adapter integrates applications separated by the firewall.

21. The method of claim 19 further comprising the step of integrating the applications over a distributed network.

22. The method of claim 21, wherein said step of integrating the applications over a distributed network further comprises the use of XML gateway.

23. The method of claim 19 further comprising the step of directly integrating the applications through a direct application interface.

24. The method of claim 19, wherein said applications are business management applications.

25. A method for integrating a first application with a second, disparate application, the method comprising the steps of:
ranking a relationship between the first and the second applications; and
integrating the first and second applications according to the ranking of the relationship, wherein said first and said second applications are either directly integrated through an API, integrated by a data adapter, or integrated over a distributed network.

26. The method of claim 25, within the data adapter is an ETL adapter or a B2B adapter, said ETL adapter integrating applications within a firewall and said B2B adapter integrating applications separated by the firewall.

27. The method of claim 25, wherein integrating said first and said second applications over a distributed network further comprises the use of an XML gateway.

28. The method of claim 25, wherein during the step of integrating the first and second applications according to the ranking of the relationship, said first and second applications may also be directly integrated through an application interface.

29. The method of claim 25, wherein said applications are business management applications.

30. A disparate applications integrator, said integrator comprising an API server having a means for internal integration, a means for ETL adapting, and a means for B2B adapting.

31. The integrator of claim 30, wherein said applications are business management applications.

32. The integrator of claim 30, wherein said API server means further includes a means of forming an XML gateway.

33. The integrator of claim 30 further comprising a means for application interfacing.

34. The integrator of claim 30, wherein said API server further includes a means for connecting applications.

35. The integrator of claim 30, wherein said API server further includes a means for normalizing data.

36. The integrator of claim 30, wherein said API server further includes a means for managing rules and mapping.

37. The integrator of claim 36, wherein said rules and mapping means is a JAVA application.

38. The integrator of claim 30, wherein said API server further includes a means for messaging.

39. The integrator of claim 30, wherein said API server further includes a means for process execution managing.

40. The integrator of claim 30, wherein said API server further includes a means for security interfacing.

41. The integrator of claim 30, wherein said API server further includes a means for log reporting.

42. The integrator of claim 30, wherein said API server further includes a means for data analyzing.

43. The integrator of claim 30, wherein said API server further includes a means for services scheduling.
